(19) United States
(12) Patent Application Publication
(10) Pub. No.: US 2026/0012966 A1
(43) Pub. Date: Jan. 8, 2026

(54) RESOURCE DETERMINATION METHOD AND APPARATUS

(71) Applicant: Beijing Xiaomi Mobile Software Co., Ltd., Beijing (CN)

(72) Inventor: Wensu ZHAO, Beijing (CN)

(73) Assignee: Beijing Xiaomi Mobile Software Co., Ltd., Beijing (CN)

(21) Appl. No.: 18/873,553

(22) PCT Filed: Jun. 17, 2022
(86) PCT No.: PCT/CN2022/099625

§ 371 Date: Dec. 10, 2024

(51) Int. Cl. H04W 72/40; H04W 72/02; H04W 72/0446

(52) U.S. Cl. CPC H04W 72/40; H04W 72/02; H04W 72/0446

(57) ABSTRACT

Disclosed are a method and apparatus for resource determination. The method includes: determining a first resource based on a slot parameter M. A time domain length of the first resource is M consecutive slots, M is a positive integer and M>1, and the first resource is used for a PSSCH or PSCCH transmission.

### CROSS-REFERENCE TO RELATED APPLICATIONS

The present application is a U.S. National Stage of International Application No. PCT/CN2022/099625, filed on Jun. 17, 2022, the content of which is incorporated herein by reference in its entirety.

### TECHNICAL FIELD

The present disclosure relates to the field of communication technologies, and in particular to a method, apparatus, and device for resource determination and a storage medium.

### BACKGROUND

In communication systems, a resource selection mechanism of sidelink (sidelink direct link) working in a licensed frequency band in R16 or R17 does not support selection of consecutive multiple slot resources, but only supports selection of a single slot resource, and does not support selection of adjacent multiple slot resources. R18 needs to study the work in sidelink. In an unlicensed frequency band, LBT needs to be performed. However, the result of LBT is uncertain. If LBT fails, data cannot be sent on a selected resource. Therefore, in order to reduce the impact of LBT failure, after one LBT success, transmission of TB(s) in multiple consecutive slots is supported. For example, one TB is repeatedly transmitted in multiple consecutive slots, or multiple TBs are transmitted in multiple consecutive slots. This can reduce the impact of LBT failure and improve the reliability of data transmission.

### SUMMARY

An embodiment of an aspect of the present disclosure provides a method for resource determination, wherein the method is performed by a terminal device, and the method includes:
determining a first resource based on a slot parameter M, wherein a time domain length of the first resource is M consecutive slots, M is a positive integer and M>1, and the first resource is used for a Physical Sidelink Shared Channel (PSSCH) or a Physical Sidelink Control Channel (PSCCH) transmission.

An embodiment of another aspect of the present disclosure provides a method for resource determination, wherein the method is performed by a network side device, and the method includes:
sending a slot parameter M to a terminal device, wherein Mis a positive integer and M>1.

An embodiment of another aspect of the present disclosure provides an apparatus for resource determination, including:
a determination module configured to determine a first resource based on a slot parameter M, wherein a time domain length of the first resource is M consecutive slots, Mis a positive integer and M>1, and the first resource is used for a PSCCH or PSSCH transmission.

An embodiment of another aspect of the present disclosure provides an apparatus for resource determination, including:
a sending module configured to send a slot parameter M to a terminal device, wherein M is a positive integer and M>1.

An embodiment of another aspect of the present disclosure provides a terminal device, including a processor and a memory, wherein the memory stores a computer program, and the processor executes the computer program stored in the memory to cause the device to perform the method according to the embodiments of the above aspect.

An embodiment of another aspect of the present disclosure provides a network side device, including a processor and a memory, wherein the memory stores a computer program, and the processor executes the computer program stored in the memory to cause the device to perform the method according to the embodiments of the above another aspect.

An embodiment of another aspect of the present disclosure provides a communication device, including: a processor and an interface circuit, wherein:
the interface circuit is configured to receive code instructions and transmit the code instructions to the processor;
the processor is configured to run the code instructions to perform the method according to embodiments of the above aspect.

An embodiment of another aspect of the present disclosure provides a communication device, including: a processor and an interface circuit, wherein:
the interface circuit is configured to receive code instructions and transmit the code instructions to the processor;
the processor is configured to run the code instructions to perform the method according to embodiments of the above another aspect.

An embodiment of another aspect of the present disclosure provides a computer-readable storage medium storing instructions, wherein when the instructions are executed, the method according to embodiments of the above aspect.

An embodiment of another aspect of the present disclosure provides computer-readable storage medium storing instructions, wherein when the instructions are executed, the method according to embodiments of the above another aspect.

### BRIEF DESCRIPTION OF THE DRAWINGS

The above and/or additional aspects and advantages of the present disclosure will become apparent and easily understood from the following description of the embodiments in conjunction with the accompanying drawings, in which:

FIG. 1 is a schematic diagram showing an example of a method for resource determination provided by an embodiment of the present disclosure;

FIG. 2 is a schematic flowchart of a method for resource determination provided by an embodiment of the present disclosure;

FIG. 3 is a schematic flowchart of a method for resource determination provided by another embodiment of the present disclosure;

FIG. 4 is a schematic diagram showing an example of a resource starting position and ending position provided by an embodiment of the present disclosure;

FIG. 5 is a schematic diagram showing an example of a resource starting position and ending position provided by an embodiment of the present disclosure;

FIG. 6 is a schematic diagram of an example of an IRB provided by an embodiment of the present disclosure.

FIG. 7 is a schematic diagram of an example of an IRB provided by an embodiment of the present disclosure;

FIG. 8 is a schematic flowchart of a method for resource determination provided by yet another embodiment of the present disclosure;

FIG. 9 is a schematic flowchart of a method for resource determination provided by yet another embodiment of the present disclosure;

FIG. 10 is a schematic flowchart of a method for resource determination provided by yet another embodiment of the present disclosure;

FIG. 11 is a schematic flowchart of a method for resource determination provided by yet another embodiment of the present disclosure;

FIG. 12 is a schematic flowchart of a method for resource determination provided by yet another embodiment of the present disclosure;

FIG. 13 is a schematic flowchart of a method for resource determination provided by yet another embodiment of the present disclosure;

FIG. 14 is a schematic flowchart of a method for resource determination provided by yet another embodiment of the present disclosure;

FIG. 15 is a schematic diagram showing an example of a method for resource determination provided by an embodiment of the present disclosure;

FIG. 16 is a schematic flowchart of a method for resource determination provided by yet another embodiment of the present disclosure;

FIG. 17 is a schematic flowchart of a method for determining a candidate resource subset provided by an embodiment of the present disclosure;

FIG. 18 is a schematic flowchart of a method for resource determination provided by yet another embodiment of the present disclosure;

FIG. 19 is a schematic flowchart of a method for resource determination provided by yet another embodiment of the present disclosure;

FIG. 20 is a schematic flowchart of a method for resource determination provided by yet another embodiment of the present disclosure;

FIG. 21 is a schematic flowchart of a method for resource determination provided by yet another embodiment of the present disclosure;

FIG. 22 is a schematic flowchart of a method for resource determination provided by yet another embodiment of the present disclosure;

FIG. 23 is a schematic flowchart of a method for resource determination provided by yet another embodiment of the present disclosure;

FIG. 24 is a schematic flowchart of a method for resource determination provided by yet another embodiment of the present disclosure;

FIG. 25 is a schematic structural diagram of an apparatus for resource determination provided by an embodiment of the present disclosure;

FIG. 26 is a schematic structural diagram of an apparatus for resource determination provided by an embodiment of the present disclosure;

FIG. 27 is a schematic structural diagram of an apparatus for resource determination provided by an embodiment of the present disclosure;

FIG. 28 is a schematic structural diagram of an apparatus for resource determination provided by an embodiment of the present disclosure;

FIG. 29 is a block diagram of a terminal device provided by an embodiment of the present disclosure;

FIG. 30 is a block diagram of a network side device provided by an embodiment of the present disclosure.

### DETAILED DESCRIPTION

Example embodiments will be described in detail herein, examples of which are shown in the accompanying drawings. When the following description refers to the drawings, the same numbers in different drawings represent the same or similar elements unless otherwise indicated. The implementations described in the following example embodiments do not represent all implementations consistent with the embodiments of the present disclosure. Instead, they are merely examples of devices and methods consistent with some aspects of the embodiments of the present disclosure as detailed in the appended claims.

The terms used in embodiments of the present disclosure are for the purpose of describing example embodiments only and are not intended to limit the embodiments of the present disclosure. As used in the embodiments of the present disclosure and the appended claims, the singular forms “a/an” and “said/the” are intended to include a plural form as well, unless the context clearly dictates otherwise. It will also be understood that the term “and/or” as used herein refers to and includes any or all possible combinations of one or more of associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, first information may also be called second information, and similarly, second information may also be called first information. Depending on the context, the word “if” and “in a case where” as used herein may be interpreted as “when” or “upon” or “in response to determining . . . ”.

The network elements or network functions involved in the embodiments of the present disclosure may be implemented by independent hardware devices or may be implemented by software in the hardware devices, and this is not limited in the embodiments of the present disclosure.

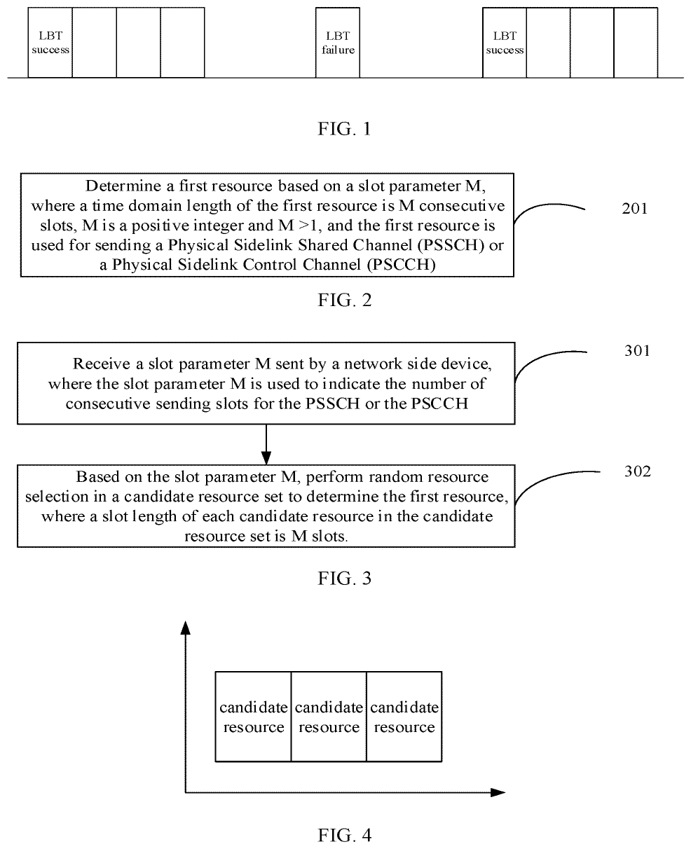

FIG. 1 is a schematic diagram of an example of a method for resource determination provided by an embodiment of the present disclosure. As shown in FIG. 1, in an unlicensed frequency band, in order to reduce the impact of a Listen Before Talk (LBT) failure, Transmission Block (TB) being transmitted in multiple consecutive slots can be supported after one LBT success. The transmission of TB in multiple consecutive slots may be continuous transmission of the same TB in multiple slots. However, in order to support the transmission of the TB in multiple consecutive slots, it is needed to select multiple consecutive resources for the same TB, for example, M resources that are continuous in a time domain. Therefore, a “resource determination” method is urgently needed. When performing resource selection, selection of consecutive multi-slot resources may be supported to determine resource(s) with a time domain length of M consecutive slots, which can improve the convenience of resource determination and the reliability of data transmission.

A method, apparatus, device for resource determination and a storage medium provided by embodiments of the present disclosure are described in detail below with reference to the accompanying drawings.

FIG. 2 is a schematic flowchart of a method for resource determination provided by an embodiment of the present disclosure. The method is performed by a terminal device. As shown in FIG. 2, the method may include the following steps:

In step 201, a first resource is determined based on a slot parameter M. A time domain length of the first resource is M consecutive slots, M is a positive integer and M>1, and the first resource is used for sending a Physical Sidelink Shared Channel (PSSCH) or a Physical Sidelink Control Channel (PSCCH).

It should be noted that, in an embodiment of the present disclosure, the terminal device may be a device that provides voice and/or data connectivity to a user. The terminal device may communicate with one or more core networks via a Radio Access Network (RAN). The terminal device may be an Internet of Things (IoT) terminal, such as a sensor device, a mobile phone (or called as a “cellular” phone), and a computer with an IoT terminal, for example, terminal device may be a fixed, portable, pocket-sized, handheld, computer-built-in, or in-vehicle device. For example, the terminal device may be a station (STA), a subscriber unit, a subscriber station, a mobile station, a mobile, a remote station, an access point, a remote terminal, an access terminal, a user terminal, or a user agent. Or, the terminal device may also be a device of an unmanned aerial vehicle. Or, the terminal device may also be an in-vehicle device, for example, it may be an on-board computer with a wireless communication function, or a wireless terminal connected to an external on-board computer. Or, the terminal device may also be a roadside device, for example, a street lamp, a signal light or other roadside device with a wireless communication function.

In an embodiment of the present disclosure, R18 needs to study work in the sidelink, and LBT needs to be performed in an unlicensed frequency band. In order to reduce the impact of a LBT failure, after one LBT success, for continuous transmission of PSSCH or PSCCH, the same TB or different TBs can be repeatedly sent in M consecutive slots.

Determining the first resource based on the slot parameter M includes:
receiving the slot parameter M sent by a network side device, where the slot parameter M is used to indicate the number of consecutive sending slots for the PSSCH or PSCCH; and
based on the slot parameter M, performing random resource selection in a candidate resource set to determine the first resource, where a slot length of each candidate resource in the candidate resource set is M slots.

And, in an embodiment of the present disclosure, the first resource further includes L_{subCH} sub-channels which are continuous or discrete in a frequency domain, and frequency domain resource starting positions and ending positions are the same or different between adjacent slots, where L_{subCH} is a positive integer.

And, in an embodiment of the present disclosure, the first resource further includes X indexes of Interlaced Resource Blocks (IRBs) which are continuous or discrete in a frequency domain, and frequency domain resource starting positions and ending positions are the same or different between adjacent slots, wherein X is a positive integer.

And, in an embodiment of the present disclosure, determining the first resource based on the slot parameter M includes:
based on the slot parameter M, determining the first resource from a candidate resource set, where a time domain length of each candidate resource in the candidate resource set is a single slot. The single slot may refer to one slot.

And, in an embodiment of the present disclosure, determining the first resource from the candidate resource set based on the slot parameter M includes at least one of the following:
based on the slot parameter M, performing multiple resource selections from the candidate resource set to determine the first resource, where a slot length for each resource selection is a single slot;
based on the slot parameter M, performing one resource selection from the candidate resource set to determine the first resource, where a slot length for the one resource selection is M slots.

For example, in an embodiment of the present disclosure, performing multiple resource selections from the candidate resource set to determine the first resource based on the slot parameter M, includes:
randomly select a first candidate resource x from the candidate resource set; and
based on the first candidate resource x, selecting, from the candidate resource set, candidate resources corresponding to M consecutive time domains as the first resource.

Furthermore, in an embodiment of the present disclosure, the method further includes:
if the first resource cannot be selected from the candidate resource set based on the first candidate resource x, reselecting a second candidate resource x from the candidate resource set, and performing selection of the first resource from the candidate resource set again based on the second candidate resource x.

Further, in an embodiment of the present disclosure, selecting, from the candidate resource set, candidate resources corresponding to M consecutive time domains as the first resource includes:
selecting, from the candidate resource set, candidate resources corresponding to M consecutive time domains according to a first selection order as the first resource.

The first order may be in the an ascending order of numbers of slots or in a descending order of numbers of slots, which is not limited in the present disclosure.

Furthermore, in an embodiment of the present disclosure, the method further includes:
if candidate resources corresponding to M consecutive time domains cannot be selected from the candidate resource set according to the first selection order, obtaining candidate resources corresponding to N consecutive time domains selected according to the first selection order as a second resource, where N is a positive integer smaller than M;
based on the first candidate resource x again, performing selection of candidate resources corresponding to M-N consecutive time domains from the candidate resource set according to a second selection order as a third resource; and
combining the second resource and the third resource into the first resource.

Further, in an embodiment of the present disclosure, the second selection order is in a direction opposite to the first selection order.

Further, in an embodiment of the present disclosure, based on the slot parameter M, performing one resource selection from the candidate resource set to determine the first resource includes:
determining a plurality of candidate resource subsets, where time domain resources in the candidate resource subset are continuous, and a length of time domain continuity is equal to or greater than M slots; and
performing selection from any one of the candidate resource subsets to select candidate resources corresponding to M consecutive time domains as the first resource.

For example, in an embodiment of the present disclosure, the method further includes:
if the first resource does not exist in the candidate resource set, stopping transmission of a TB.

Furthermore, in an embodiment of the present disclosure, the method further includes:
if the first resource does not exist in the candidate resource set, randomly selecting a fourth resource from the candidate resource set, where a time domain length of the fourth resource is a single slot; and
transmitting one TB in a single slot.

Furthermore, in an embodiment of the present disclosure, the method further includes:
if the first resource does not exist in the candidate set, selecting a fifth resource from the candidate set, wherein a time domain length of the fifth resource is L consecutive slots, L is a positive integer, and L is a positive integer smaller than M.

Furthermore, in an embodiment of the present disclosure, the method further includes:
repeatedly sending a same TB or different TBs in the M consecutive slots or in the L consecutive slots.

In summary, in the embodiments of the present disclosure, based on the slot parameter M, the first resource is determined. The time domain length of the first resource is M consecutive slots, M is a positive integer and M>1. The first resource is used for sending the PSSCH or PSCCH. In the embodiments of the present disclosure, through the slot parameter M, a resource with a time domain length of M consecutive slots can be selected. This can address the situation where consecutive multi-slot resources cannot be selected based on the R16 or R17 sidelink resource selection mechanism. The present disclosure provides a processing method for a “resource determination” scenario, which can support the selection of consecutive multi-slot resources during resource selection to determine resource(s) with a time domain length of M consecutive slots. Thus, the embodiments of the present disclosure can facilitate the convenience of resource determination and improve the reliability of data transmission.

FIG. 3 is a schematic flowchart of a method for resource determination provided by an embodiment of the present disclosure. The method is performed by a terminal device. As shown in FIG. 3, the method may include the following steps:

In step 301, a slot parameter M sent by a network side device is received, where the slot parameter M is used to indicate the number of consecutive slots for the PSSCH or the PSCCH transmission.

In step 302, based on the slot parameter M, random resource selection is performed in a candidate resource set to determine the first resource, where a slot length of each candidate resource in the candidate resource set is M slots.

In an embodiment of the present disclosure, the first resource further includes L_{subCH} sub-channels which are continuous or discrete in a frequency domain, and frequency domain resource starting positions and ending positions are the same or different between adjacent slots, wherein L_{subCH} is a positive integer.

And, in an embodiment of the present disclosure, a sub-channel is a set containing a number of consecutive Resource Blocks (RBs), which is used for PSCCH or PSSCH transmission. The transmission resource(s) for a sidelink UE is (are) allocated with sub-channel as the granularity.

For example, in an embodiment of the present disclosure, the slot length of a candidate resource may be, for example, 3 slots. FIG. 4 is a schematic diagram of an example of a resource starting position and ending position provided by an embodiment of the present disclosure. As shown in FIG. 4, the first resource further includes L_{subCH} sub-channels which are continuous or discrete in a frequency domain, and frequency domain resource starting positions and ending positions are the same between adjacent slots.

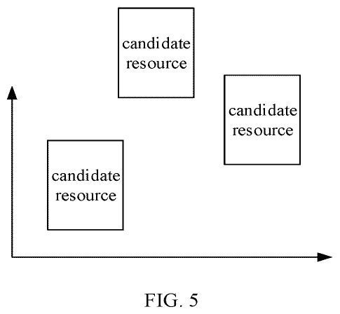

For example, in an embodiment of the present disclosure, the slot length of a candidate resource may be, for example, 3 slots. FIG. 5 is a schematic diagram of an example of a resource starting position and ending position provided by an embodiment of the present disclosure. As shown in FIG. 5, the first resource further includes L_{subCH} sub-channels which are continuous or discrete in a frequency domain, and the frequency domain resource starting positions and ending positions are different between adjacent slots. Each candidate resource may correspond to a sub-channel.

For example, in an embodiment of the present disclosure, the first resource further includes X indexes of Interlaced Resource Blocks (IRBs) which are continuous or discrete in a frequency domain, and frequency domain resource starting positions and ending positions are the same or different between adjacent slots, where X is a positive integer. For example, in an embodiment of the present disclosure, an Interlaced Resource Block (IRB) may be introduced in a 5G air interface system operating in an unlicensed frequency band (New Radio in Unlicensed Spectrum, NR-U), that is, two consecutive available resource blocks are separated by M resource blocks. For an IRB index m, the Physical Resource Block (PRB) included therein may be, for example, {m,M+m,2M+m,3M+m, . . . }, where m∈{0,1, . . . ,M−1}. In the NR-U system, IRB structures are defined for sub-carrier spacing of 15 kHz and 30 kHz, respectively, as shown in Table 1:

TABLE 1

| μ | M |
|---|---|
| 0 | 10 |
| 1 | 5 |

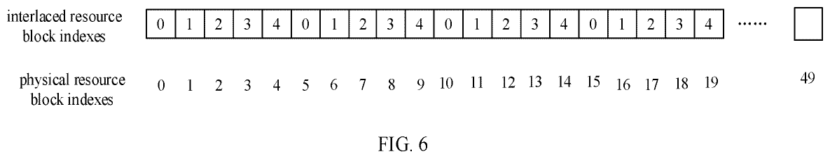

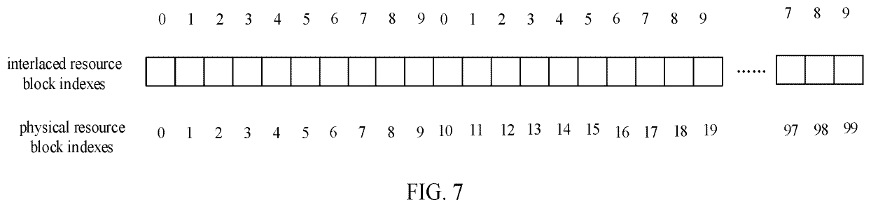

For example, in an embodiment of the present disclosure, FIG. 6 is a schematic diagram of an example of an IRB provided in an embodiment of the present disclosure. As shown in FIG. 6, the sub-carrier spacing (SCS) may be, for example, 30 kHz. That is, when SCS=30 kHz and M=5, there are 5 IRB indexes. For an IRB index, that is, IRB index 0, the interlaced resource blocks contained in the IRB index may be, for example, PRB {0, 5, 10, 15, 20, 25, 30, 35, 40, 45}. FIG. 7 is a schematic diagram of an example of an IRB provided in an embodiment of the present disclosure. As shown in FIG. 7, SCS=15 kHz, and M=10.

For example, in an embodiment of the present disclosure, the terminal device performs random resource selection in a candidate resource set based on the slot parameter M to determine the first resource. The time domain length of the first resource is M consecutive slots, and the terminal device may repeatedly send the same Transmission Block (TB) in the M consecutive slots. In other words, the first resource is used for repeated transmission of the same TB, or may also be used for continuous transmission of M TBs in the M slots.

For example, in an embodiment of the present disclosure, when the terminal device obtains the slot parameter M, the terminal device may also receive at least one of the following parameters to determine the first resource:
a resource pool from which a resource is to be reported;
layer 1 (L1) priority;
remaining packet delay budget;
the number of sub-channels or the number of IRB indexes for PSSCH or PSCCH transmission in a slot; or
a resource reservation interval.

For example, in an embodiment of the present disclosure, when the terminal device receives the slot parameter M, the resource pool from which a resource is to be reported, the L1 priority, the remaining packet delay budget, the number of sub-channels or the number of IRB indexes for PSSCH or PSCCH transmission in a slot, and the resource reservation interval, the terminal device can determine a candidate resource set to determine the first resource.

For example, in an embodiment of the present disclosure, the parameters received by the terminal device may include, for example, the slot parameter M, the resource pool from which the resource is to be reported, the layer 1 (L1) priority, the remaining packet delay budget, the number of sub-channels or the number of IRB indexes for PSSCH or PSCCH transmission in a slot, and the resource reservation interval. The terminal device can determine a candidate resource set based on these parameters, and perform random resource selection in the candidate resource set to determine the first resource. When the terminal device determines the candidate resource set, the terminal device can, for example, determine the candidate resource set through sensing and resource exclusion, for example, the procedure of determining the candidate resource set in sidelink in the 5G R16 or R17 standard can be followed.

In summary, in the embodiment of the present disclosure, the slot parameter M sent by the network side device is received. The slot parameter Mis used to indicate the number of consecutive sending slots for the PSSCH or PSCCH. Based on the slot parameter M, the first resource is determined, M is a positive integer and M>1, and the first resource is used for sending of PSSCH or PSCCH. In the embodiments of the present disclosure, through the slot parameter M, a resource with a time domain length of M consecutive slots can be selected. This can address the situation where consecutive multi-slot resources cannot be selected based on the R16 or R17 sidelink resource selection mechanism. The present disclosure provides a processing method for a “resource determination” scenario, which can support the selection of consecutive multi-slot resources during resource selection to determine a resource with a time domain length of M consecutive slots. Thus, the embodiments can facilitate the convenience of resource determination and improve the reliability of data transmission.

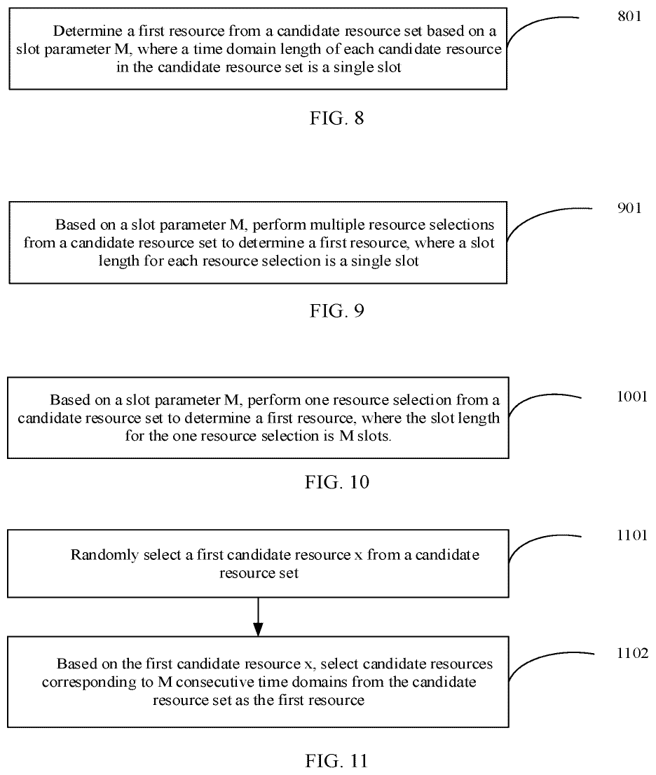

FIG. 8 is a schematic flowchart of a method for resource determination provided by an embodiment of the present disclosure. The method is performed by a terminal device. As shown in FIG. 8, the method may include the following steps:

In step S801, a first resource is determined from a candidate resource set based on a slot parameter M, where a time domain length of each candidate resource in the candidate resource set is a single slot.

In an embodiment of the present disclosure, the terminal device may determine a candidate resource set using a procedure specified in R16 or R17, that is, the candidate resource set is a resource set determined by the terminal device using a resource determination method of R16 or R17. The candidate resource set does not specifically refer to a fixed set. For example, when the number of candidate resources included in the candidate resource set changes, the candidate resource set may also change accordingly.

In summary, in the embodiment of the present disclosure, based on the slot parameter M, the first resource is determined from the candidate resource set, wherein the time domain length of each candidate resource in the candidate resource set is a single slot. In the embodiment of the present disclosure, through the slot parameter M, a resource with a time domain length of M consecutive slots can be selected from the candidate resource set in which the time domain length of each candidate resource is a single slot. Thus, the embodiment can address the situation in which consecutive multi-slot resources cannot be selected based on the R16 or R17 sidelink resource selection mechanism. The present disclosure provides a processing method for a “resource determination” scenario, which can support the selection of consecutive multi-slot resources during resource selection to determine a resource with a time domain length of M consecutive slots. Thus, the embodiments can facilitate the convenience of resource determination and improve the reliability of data transmission.

FIG. 9 is a schematic flowchart of a method for resource determination provided by an embodiment of the present disclosure. The method is performed by a terminal device. As shown in FIG. 9, the method may include the following steps:

In step 901, based on a slot parameter M, multiple resource selections are performed from a candidate resource set to determine a first resource, where a slot length for each resource selection is a single slot.

In the embodiment of the present disclosure, based on the slot parameter M, the terminal device can perform multiple resource selections from the candidate resource set, and the slot length for each resource selection is a single slot, and consecutive resources with a length of M slots can be selected.

In summary, in the embodiment of the present disclosure, based on the slot parameter M, multiple resource selections are performed from the candidate resource set to determine the first resource, where the slot length for each resource selection is a single slot. In the embodiment of the present disclosure, since the slot length for each resource selection in the candidate resource set is a single slot, multiple resource selections can be performed based on the slot parameter M to select resources with a time domain length of M consecutive slots. Thus, the embodiment can reduce the situation where consecutive multi-slot resources cannot be selected. In the embodiment of the present disclosure, the feature of performing multiple resource selections to determine the first resource is specifically described. The present disclosure provides a processing method for a “resource determination” scenario, which can support the selection of consecutive multi-slot resources during resource selection to determine resources with a time domain length of M consecutive slots. Thus, the embodiment can facilitate the convenience of resource determination and improve the reliability of data transmission.

FIG. 10 is a schematic flowchart of a method for resource determination provided by an embodiment of the present disclosure. The method is performed by a terminal device. As shown in FIG. 10, the method may include the following steps:

In step 1001, based on a slot parameter M, one resource selection is performed from a candidate resource set to determine a first resource. The slot length for the one resource selection is M slots.

In summary, in the embodiment of the present disclosure, based on the slot parameter M, one resource selection is performed from the candidate resource set to determine the first resource, where the slot length for the one resource selection is M slots. In the embodiment of the present disclosure, resources with a time domain length of M consecutive slots can be selected at one time from the candidate resource set. The embodiment can address the situation where consecutive multi-slot resource selection cannot be performed based on the R16 or R17 sidelink resource selection mechanism. In the embodiment of the present disclosure, the feature of performing one resource selection to determine the first resource is specifically described. The present disclosure provides a processing method for a “resource determination” scenario, which can support the selection of consecutive multi-slot resources during resource selection to determine resources with a time domain length of M consecutive slots. Thus, the embodiment can facilitate the convenience of resource determination and improve the reliability of data transmission.

FIG. 11 is a schematic flowchart of a method for resource determination provided by an embodiment of the present disclosure. The method is performed by a terminal device. As shown in FIG. 11, the method may include the following steps:

In step 1101, a first candidate resource x is randomly selected from a candidate resource set.

In step 1102, based on the first candidate resource x, candidate resources corresponding to M consecutive time domains are selected from the candidate resource set as the first resource.

In an embodiment of the present disclosure, the time domain length of the first candidate resource x is 1 slot, and the first candidate resource belongs to a resource in the candidate resource set.

For example, in an embodiment of the present disclosure, when the terminal device selects the first candidate resource x, the terminal device may select candidate resources corresponding to M consecutive time domains from the candidate resource set based on the first candidate resource x as the first resource.

In summary, in the embodiment of the present disclosure, the first candidate resource x is randomly selected from the candidate resource set, and based on the first candidate resource x, candidate resources corresponding to M consecutive time domains are selected from the candidate resource set as the first resource. In the embodiment of the present disclosure, resources with a time domain length of M consecutive slots can be selected from the candidate resource set. This embodiment can address the situation where consecutive multi-slot resource selection cannot be performed based on the R16 or R17 sidelink resource selection mechanism. In the embodiment of the present disclosure, the feature of performing multiple resource selections according to a first selection order to determine the first resource is specifically described. The present disclosure provides a processing method for a “resource determination” scenario, which can support the selection of consecutive multi-slot resources during resource selection to determine resources with a time domain length of M consecutive slots. Thus, the embodiment can facilitate the convenience of resource determination and improve the reliability of data transmission.

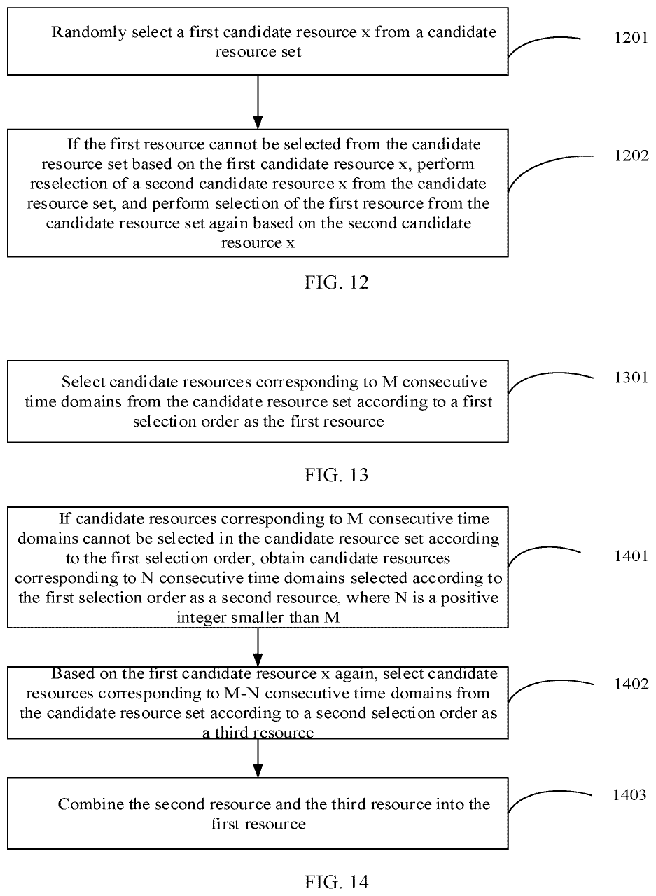

FIG. 12 is a schematic flowchart of a method for resource determination provided by an embodiment of the present disclosure. The method is performed by a terminal device. As shown in FIG. 12, the method may include the following steps:

In step 1201, a first candidate resource x is randomly selected from a candidate resource set.

In step 1202, if the first resource cannot be selected from the candidate resource set based on the first candidate resource x, reselection of a second candidate resource x from the candidate resource set is performed, and selection of the first resource from the candidate resource set is performed again based on the second candidate resource x.

In an embodiment of the present disclosure, the time domain length of the first candidate resource x is 1 slot, and the first candidate resource belongs to a resource in the candidate resource set.

For example, in an embodiment of the present disclosure, when the terminal device selects the first candidate resource x, the terminal device may select candidate resources corresponding to M consecutive time domains from the candidate resource set based on the first candidate resource x. If the first resource cannot be selected from the candidate resource set based on the first candidate resource x, reselection of the second candidate resource x is performed from the candidate resource set, and selection of the first resource is performed again from the candidate resource set based on the second candidate resource x.

In an embodiment of the present disclosure, the wording “second” in the second candidate resource x is only used to distinguish it from other candidate resource(s), and does not specifically refer to a fixed candidate resource. The terminal device can, for example, select the first resource from the candidate resource set based on the first candidate resource x. If the terminal device does not select the first resource from the candidate resource set, the terminal device, for example, performs reselection of the second candidate resource x from the candidate resource set, and performs selection of the first resource from the candidate resource set again based on the second candidate resource x. For example, the second candidate resource x can be reselected from the candidate resource set excluding the first candidate resource x, and selection of the first resource can be performed from the candidate resource set again based on the second candidate resource x.

For example, in an embodiment of the present disclosure, if the first resource cannot be selected from the candidate resource set based on the second candidate resource x, reselection of a third candidate resource x is performed from the candidate resource set, and selection of the first resource is performed again from the candidate resource set based on the third candidate resource x.

In summary, in the embodiment of the present disclosure, if the first resource cannot be selected from the candidate resource set based on the first candidate resource x, reselection of the second candidate resource x is performed from the candidate resource set, and selection of the first resource is performed from the candidate resource set again based on the second candidate resource x. In the embodiment of the present disclosure, through the slot parameter M, resources with a time domain length of M consecutive slots can be selected from the candidate resource set. This embodiment can address the situation where consecutive multi-slot resource selection cannot be performed based on the R16 or R17 sidelink resource selection mechanism. The embodiment of the present disclosure specifically describes the feature of performing multiple resource selections according to a first selection order, and if the first resource cannot be determined based on the first candidate resource x, determining the first resource based on the second candidate resource x. The present disclosure provides a processing method for a “resource determination” scenario, which can support the selection of consecutive multi-slot resources during resource selection to determine resources with a time domain length of M consecutive slots. Thus, the embodiment can facilitate the convenience of resource determination and improve the reliability of data transmission.

FIG. 13 is a schematic flowchart of a method for resource determination provided in an embodiment of the present disclosure. The method is performed by a terminal device. As shown in FIG. 13, the method may include the following steps: In step 1301, candidate resources corresponding to M consecutive time domains are selected from the candidate resource set according to a first selection order as the first resource.

In an embodiment of the present disclosure, the first selection order does not specifically refer to a fixed selection order. The wording “first” in the first selection order is only used to distinguish from other selection orders. For example, the terminal device can select candidate resources corresponding to M consecutive time domains from the candidate resource set according to the first selection order based on the first candidate resource x, and use them as the first resource.

For example, in an embodiment of the present disclosure, for example, the time domain corresponding to the first candidate resource x may be, for example, a. The first selection order may be, for example, a selection order from a time domain α−1 to a time domain a−M+1. The selection order from the time domain α−1 to the time domain α−M+1 may refer to a selection order from a slot α−1 to a slot α−M+1, or a selection order from time α−1 to time α−M+1.

For example, in an embodiment of the present disclosure, the first selection order may be, for example, a selection order from the time domain α−1 to the time domain α−M+1. According to the first selection order from the time domain α−1 to the time domain α−M+1, the terminal device may select a candidate resource from the time domain α−1 to the time domain α−M+1, respectively to determine the first resource. For example, the terminal device may first perform selection of a candidate resource in the time domain α−1. If a resource is selected by the terminal device in the time domain α−1, the terminal device may continue to perform selection of a resource in the time domain α−2 according to the first selection order. If a resource is selected by the terminal device in the time domain α−2, the terminal device may continue to perform selection of a resource in the time domain α−3 according to the first selection order. According to the first selection order, if one resource is selected from each of the time domain α−1 to the time domain α−M+1, all selected resources may constitute a first resource, that is, all selected resources can constitute the first resource having a time domain length of M consecutive slots.

For example, in an embodiment of the present disclosure, if the first resource cannot be selected from the candidate resource set based on the first candidate resource x, reselection of a second candidate resource x is performed from the candidate resource set, and selection of the first resource is performed again from the candidate resource set based on the second candidate resource x. The terminal device may select candidate resources corresponding to M consecutive time domains from the candidate resource set according to the first selection order based on the second candidate resource x, and use them as the first resource.

For example, in an embodiment of the present disclosure, a time domain corresponding to the second candidate resource x may be, for example, c. The terminal device selects, from the candidate resource set, candidate resources corresponding to M consecutive time domains in accordance with a first selection order from a time domain c−1 to a time domain c−M+1, and uses them as the first resource. For example, the terminal device may first select a candidate resource in the time domain c−1. If a resource is selected by the terminal device in the time domain c−1, the terminal device may continue to perform selection of a resource in the time domain c−2 in accordance with the first selection order. If a resource is selected by the terminal device in the time domain c−2, the terminal device may continue to perform selection of a resource in the time domain c−3 in accordance with the first selection order. According to the first selection order, if a resource is selected from each of the time domain c−1 to the time domain c−M+1, all selected resources may constitute the first resource, that is, all selected resources may constitute the first resource having a time domain length of M consecutive slots.

In summary, in the embodiment of the present disclosure, candidate resources corresponding to M consecutive time domains are selected from the candidate resource set according to the first selection order as the first resource. In the embodiment of the present disclosure, resources with a time domain length of M consecutive slots can be selected from the candidate resource set. This can address the situation where consecutive multi-slot resources cannot be selected based on the R16 or R17 sidelink resource selection mechanism. In the embodiment of the present disclosure, the feature of performing multiple resource selections according to the first selection order to determine the first resource is specifically described. The present disclosure provides a processing method for a “resource determination” scenario, which can support the selection of consecutive multi-slot resources during resource selection to determine resources with a time domain length of M consecutive slots. Thus, the embodiment can facilitate the convenience of resource determination and improve the reliability of data transmission.

FIG. 14 is a schematic flowchart of a method for resource determination provided by an embodiment of the present disclosure. The method is performed by a terminal device. As shown in FIG. 14, the method may include the following steps:

In step 1401, if candidate resources corresponding to M consecutive time domains cannot be selected in the candidate resource set according to the first selection order, candidate resources corresponding to N consecutive time domains selected according to the first selection order are obtained as a second resource, where N is a positive integer smaller than M.

In step 1402, based on the first candidate resource x again, candidate resources corresponding to M-N consecutive time domains are selected from the candidate resource set according to a second selection order as a third resource.

In step 1403, the second resource and the third resource are combined into the first resource.

For example, in an embodiment of the present disclosure, the first selection order does not specifically refer to a fixed order. The wording “first” in the first selection order is only used to distinguish from the second selection order. The second selection order does not specifically refer to a fixed selection order. The wording “second” in the second selection order is only used to distinguish from other selection orders. The second selection order is in a direction opposite to the first selection order.

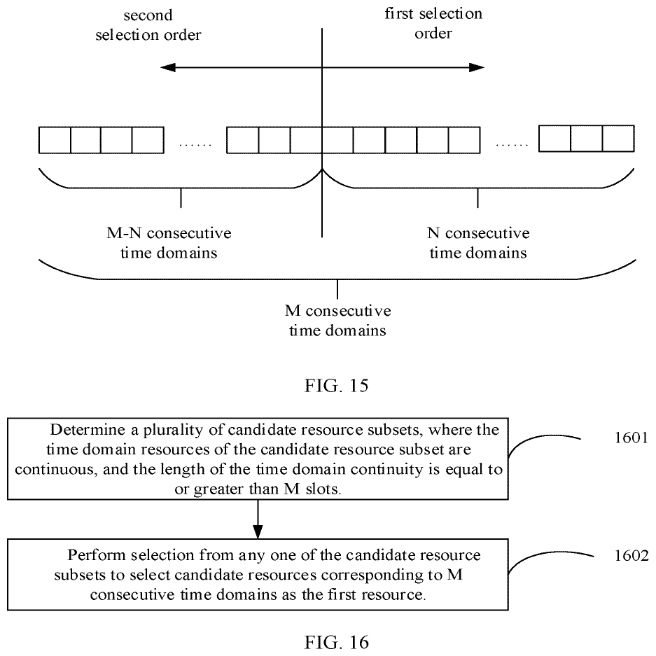

In an embodiment of the present disclosure, FIG. 15 is a schematic diagram of an example of a method for resource determination provided by an embodiment of the present disclosure. As shown in FIG. 15, the terminal device can, for example, obtain candidate resources corresponding to N consecutive time domains selected according to a first selection order as the second resource, select candidate resources corresponding to M-N consecutive time domains from the candidate resource set according to a second selection order as the third resource, and combine the second resource and the third resource into the first resource.

For example, in an embodiment of the present disclosure, for example, the time domain corresponding to the first candidate resource x may be, for example, a. The first selection order may be, for example, the selection order from the time domain α−1 to the time domain α−M+1. The terminal device may, for example, select candidate resources corresponding to M consecutive time domains according to the first selection order from the time domain α−1 to the time domain α−M+1. For example, one resource may be selected from the time domain α−1 to the time domain α−M+1 respectively. If there is any time domain α−N−1 for which a candidate resource cannot be selected, the terminal device may obtain candidate resources corresponding to N consecutive time domains selected according to the first selection order as the second resource, and may not select candidate resources between the time domain a−N−1 to the time domain α−M+1. The time domain length of the second resource is N consecutive slots, that is, the terminal device can determine N slots.

For example, in an embodiment of the present disclosure, the terminal device may obtain a difference between M and N, that is, the terminal device may determine M-N consecutive time domains, and the M-N time domains may be, for example, R time domains. For example, the terminal device may select, from the candidate resource set, a resource from the time domain a+1 to the time domain a+M+1, respectively, according to the second selection order from the time domain a+1 to the time domain a+M=1, and the terminal device may determine R consecutive slots as the third resource. The terminal device may combine the second resource and the third resource into the first resource. That is, the terminal device may combine N consecutive slots and R consecutive slots into M consecutive slots.

For example, in an embodiment of the present disclosure, the terminal device combines the second resource and the third resource into the first resource, and the terminal device no longer continues to perform resource selection.

For example, in an embodiment of the present disclosure, the terminal device may perform resource selection according to the second selection order from the time domain a+1 to the time domain a+M=1. For example, the terminal device may select, in the candidate resource set, one resource from the time domain a+1 to the time domain a+M+1 respectively. According to the second selection order from the time domain a+1 to the time domain a+M−1, if there is any time domain a+B for which a candidate resource cannot be selected, the terminal device does not select candidate resource(s) between the time domain a-B to the time domain a+M+1.

For example, in an embodiment of the present disclosure, the terminal device may randomly reselect a second candidate resource x from a candidate resource set excluding the first candidate resource x. The second candidate resource x is different from the first candidate resource x. For example, the terminal device may select candidate resources corresponding to M consecutive time domains from the candidate resource set in accordance with the first selection order based on the second candidate resource x, and use them as the first resource. If, based on the second candidate resource x, the candidate resources corresponding to M consecutive time domains cannot be selected in the candidate resource set in accordance with the first selection order, candidate resources corresponding to N consecutive time domains selected in accordance with the first selection order are obtained as the second resource, where N is a positive integer smaller than M. And, based on the second candidate resource x again, candidate resources corresponding to M-N consecutive time domains are selected from the candidate resource set in accordance with the second selection order, and used as the third resource. The terminal device may combine the second resource and the third resource into the first resource.

For example, in an embodiment of the present disclosure, the time domain corresponding to the second candidate resource x may be, for example, c. The terminal device selects, from the candidate resource set, candidate resources corresponding to M consecutive time domains in accordance with the first selection order from the time domain c−1 to the time domain c−M+1, and uses them as the first resource. For example, the terminal device may first select a candidate resource in the time domain c−1. If a resource is selected by the terminal device in the time domain c−1, the terminal device may continue to perform selection of a resource in the time domain c−2 in accordance with the first selection order. If a resource is selected by the terminal device in the time domain c−2, the terminal device may continue to perform selection of a resource in the time domain c−3 in accordance with the first selection order. According to the first selection order, if a resource is selected from each of the time domain c−1 to the time domain c−M+1, all selected resources may constitute the first resource, that is, all selected resources may constitute the first resource having a time domain length of M consecutive slots. If there is any time domain c−N−1 for which a candidate source cannot be selected, the terminal device may obtain the candidate resources corresponding to N consecutive time domains selected according to the first selection order and use them as the second resource, and the terminal device does not select the candidate resource(s) between the time domain c−N−1 and the time domain c−M+1. The time domain length of the second resource is N consecutive slots.

For example, in an embodiment of the present disclosure, the terminal device can obtain a difference between M and N, that is, the terminal device may determine M-N consecutive time domains. For example, the terminal device may select, from the candidate resource set, a resource from the time domain c+1 to the time domain c+M+1, respectively, according to the second selection order from the time domain c+1 to the time domain c+M=1, and the terminal device may determine M-N slots as the third resource. The terminal device may combine the second resource and the third resource into the first resource, that is, the terminal device may combine N consecutive slots and M-N consecutive slots into M consecutive slots.

In summary, in the embodiments of the present disclosure, if the candidate resources corresponding to the M consecutive time domains cannot be selected in the candidate resource set according to the first selection order, the candidate resources corresponding to the N consecutive time domains selected in the first selection order are obtained and used as the second resource, where Nis a positive integer smaller than M. And, based on the first candidate resource x again, candidate resources corresponding to the M-N consecutive time domains are selected from the candidate resource set according to the second selection order and used as the third resource. The second resource and the third resource are combined as the first resource. In the embodiment of the present disclosure, through the slot parameter M, the first resource with a time domain length of M consecutive slots can be selected in the candidate resource set, so as to address the situation that consecutive multi-slot resource selection cannot be performed based on the R16 or R17 sidelink resource selection mechanism. In the embodiments of the present disclosure, the feature of performing multiple resource selections according to the first selection order and the second selection order to determine the first resource is specifically described. The present disclosure provides a processing method for a “resource determination” scenario, which can support the selection of consecutive multi-slot resources during resource selection to determine the resources with a time domain length of M consecutive slots. Thus, the embodiments can facilitate the convenience of resource determination and improve the reliability of data transmission.

FIG. 16 is a schematic flowchart of a method for resource determination provided in an embodiment of the present disclosure. The method is performed by a terminal device. As shown in FIG. 16, the method may include the following steps:

In step 1601, a plurality of candidate resource subsets are determined. The time domain resources of the candidate resource subset are continuous, and the length of the time domain continuity is equal to or greater than M slots.

In step 1602, selection from any one of the candidate resource subsets is performed to select candidate resources corresponding to M consecutive time domains as the first resource.

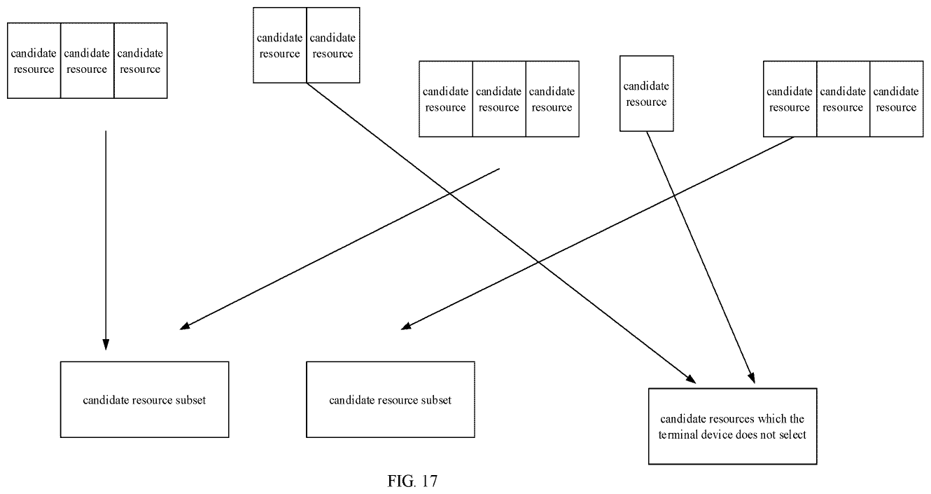

In an embodiment of the present disclosure, FIG. 17 is a schematic flowchart of a method for determining a candidate resource subset provided by an embodiment of the present disclosure. As shown in FIG. 17, for example, the time domain resources of a candidate resource subset may be continuous, and the length of the time domain continuity is equal to or greater than 3 slots. The terminal device may identify at least one candidate resource in the candidate resource set, and select multiple candidate subsets whose time domain continuity length is equal to or greater than 3 slots. The slot parameter M may be 3, for example. Based on the slot parameter M, candidate resources corresponding to three consecutive time domains may be selected from the candidate resource subset as the first resource. If there are multiple candidate resources corresponding to multiple M consecutive time domains in the candidate resource subset, the terminal device may randomly select one candidate resource from the candidate resources corresponding to multiple M consecutive time domains as the first resource.

In summary, in the embodiment of the present disclosure, multiple candidate resource subsets are determined, wherein the time domain resources of the candidate resource subset are continuous, and the length of the time domain continuity is equal to or greater than M slots. Random resource selection is performed in any candidate resource subset to select candidate resources corresponding to M consecutive time domains as the first resource. In the embodiment of the present disclosure, through the slot parameter M, resources with a time domain length of M consecutive slots can be selected from the candidate resource set, so as to address the situation where consecutive multi-slot resources cannot be selected based on the R16 or R17 sidelink resource selection mechanism. In the embodiment of the present disclosure, the feature of performing one resource selection to determine the first resource is specifically described. By identifying at least one candidate resource in the candidate resource set, the accuracy of obtaining the candidate resource subset can be improved, and the accuracy of determining the first resource can be improved. The present disclosure provides a processing method for a “resource determination” scenario, which can support the selection of consecutive multi-slot resources during resource selection to determine resources with a time domain length of M consecutive slots. Thus, the embodiment can facilitate the convenience of resource determination and improve the reliability of data transmission.

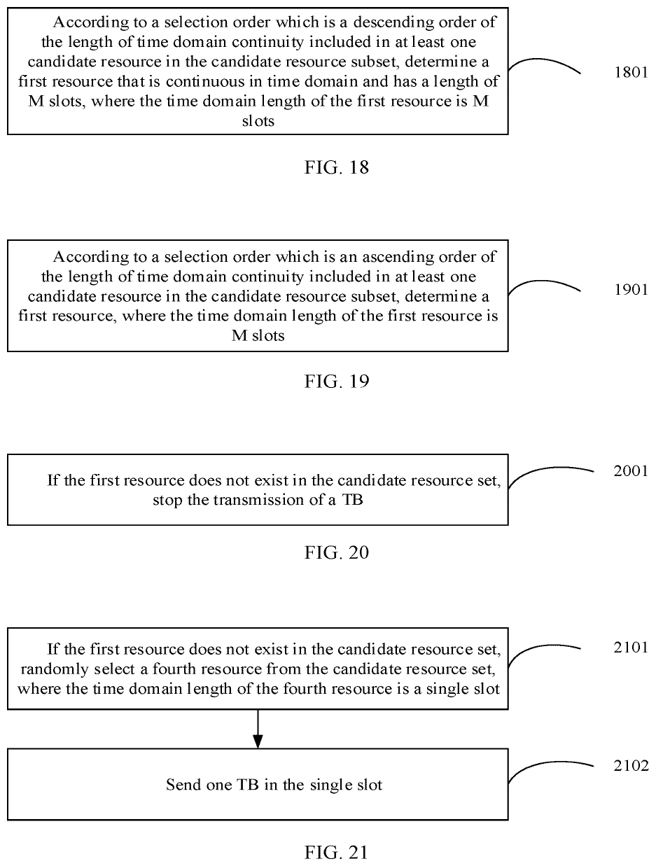

FIG. 18 is a schematic flowchart of a method for resource determination provided by an embodiment of the present disclosure. The method is performed by a terminal device. As shown in FIG. 18, the method may include the following steps:

In step 1801, according to a selection order which is a descending order of the length of time domain continuity included in at least one candidate resource in a candidate resource subset, a first resource that is continuous in time domain and has a length of M slots is determined. The time domain length of the first resource is M slots.

In an embodiment of the present disclosure, according to the selection order which is the descending order of the length of time domain continuity included in at least one candidate resource in the candidate resource subset, the terminal device may determine the first candidate resource that is continuous in the time domain and has a length of M slots as the first resource.

In summary, in the embodiment of the present disclosure, according to the selection order which is the descending order of the length of time domain continuity included in at least one candidate resource in the candidate resource subset, a first resource with is continuous in the time domain and has a length of M slots is determined. The time domain length of the first resource is M slots. In the embodiment of the present disclosure, through the slot parameter M, a resource with a time domain length of M slots can be selected in the candidate resource set, so as to address the situation where consecutive multi-slot resources cannot be selected based on the R16 or R17 sidelink resource selection mechanism. In the embodiment of the present disclosure, the feature of performing one resource selection to determine the first resource is specifically described. By identifying at least one candidate resource in the candidate resource set, the accuracy of obtaining the candidate resource subset can be improved. The first resource is determined according to the selection order which is the descending order of the length of time domain continuity included in at least one candidate resource, which can improve the accuracy of the first resource determination. The present disclosure provides a processing method for a “resource determination” scenario, which can support the selection of consecutive multi-slot resources during resource selection to determine the resources with a time domain length of M slots. Thus, the embodiment can facilitate the convenience of resource determination and improve the reliability of data transmission.

FIG. 19 is a schematic flowchart of a method for resource determination provided by an embodiment of the present disclosure. The method is performed by a terminal device. As shown in FIG. 19, the method may include the following steps:

In step 1901, according to a selection order which is an ascending order of the length of time domain continuity included in at least one candidate resource in the candidate resource subset, a first resource is determined, where the time domain length of the first resource is M slots.

In an embodiment of the present disclosure, according to the selection order which is the ascending order of the length of time domain continuity included in at least one candidate resource in the candidate resource subset, the terminal device may determine the first one of the at least one candidate resource that is continuous in the time domain and has a length of M slots as the first resource.

In summary, in the embodiment of the present disclosure, the first resource is determined according to the selection order which is the ascending order of the length of time domain continuity included in at least one candidate resource in the candidate resource subset, wherein the time domain length of the first resource is M slots. In the embodiment of the present disclosure, through the slot parameter M, a resource of M slots continuous in the time domain can be selected in the candidate resource set, so as to address the situation where consecutive multi-slot resources cannot be selected based on the R16 or R17 sidelink resource selection mechanism. In the embodiment of the present disclosure, the feature of performing one resource selection to determine the first resource is specifically described. By identifying at least one candidate resource in the candidate resource set, the accuracy of obtaining the candidate resource subset can be improved. The first resource is determined according to the selection order which is the ascending order of the length of time domain continuity included in at least one candidate resource, which can improve the accuracy in determination of the first resource. The present disclosure provides a processing method for a “resource determination scenario, which can support the selection of consecutive multi-slot resources during resource selection to determine resources with a time domain length of M consecutive slots. Thus, the embodiment can facilitate the convenience of resource determination and improve the reliability of data transmission.

FIG. 20 is a schematic flowchart of a method for resource determination provided by an embodiment of the present disclosure. The method is performed by a terminal device. As shown in FIG. 20, the method may include the following steps:

In step 2001, if the first resource does not exist in the candidate resource set, the transmission of a TB is stopped.

In an embodiment of the present disclosure, the terminal device may perform selection of a first resource from a candidate resource set based on a slot parameter. If the first resource does not exist in the candidate resource set, the terminal device may stop transmitting a TB.

In summary, in the embodiment of the present disclosure, if the first resource does not exist in the candidate resource set, the transmission of the TB is stopped. In the embodiment of the present disclosure, if the first resource does not exist in the candidate resource set, the transmission of the TB can be stopped, the embodiment can reduce resource consumption caused by transmission of same TB. The present disclosure provides a processing method for a “resource determination” scenario. The embodiment can stop the transmission of the TB if the first resource does not exist in the candidate resource set, thereby reducing resource consumption.

FIG. 21 is a schematic flowchart of a method for resource determination provided by an embodiment of the present disclosure. The method is performed by a terminal device. As shown in FIG. 21, the method may include the following steps:

In step 2101, if the first resource does not exist in the candidate resource set, a fourth resource is randomly selected from the candidate resource set, where the time domain length of the fourth resource is a single slot.

In step 2102, one TB is sent in the single slot.

In an embodiment of the present disclosure, the terminal device may perform selection of the first resource in the candidate resource set based on the slot parameter. If the first resource does not exist in the candidate resource set, the fourth resource is randomly selected in the candidate resource set. The time domain length of the fourth resource is a single slot, that is, the terminal device may randomly select a single slot in the candidate resource set, and the terminal may send a TB in the single slot. When the terminal device performs random selection of the fourth resource in the candidate resource set, the terminal device may perform a R16 procedure, that is, the terminal device randomly selects the fourth resource with a single slot. That is, the terminal device does not perform the transmission of M consecutive slots.

Furthermore, in an embodiment of the present disclosure, the fourth resource does not specifically refer to a fixed resource. For example, when a single slot changes, the fourth resource may also change accordingly.

In summary, in the embodiment of the present disclosure, if the first resource does not exist in the candidate resource set, a fourth resource is randomly selected from the candidate resource set, and the time domain length of the fourth resource is a single slot, and a TB can be sent in the single slot. In the embodiment of the present disclosure, if the first resource does not exist in the candidate resource set, it is determined that the terminal device cannot use M consecutive slots to send the same TB, and the terminal device can send a TB in a single slot. The embodiment can reduce the situation where the same TB cannot be transmitted. The present disclosure provides a processing method for a “resource determination” scenario, and the method can send a TB in a single slot.

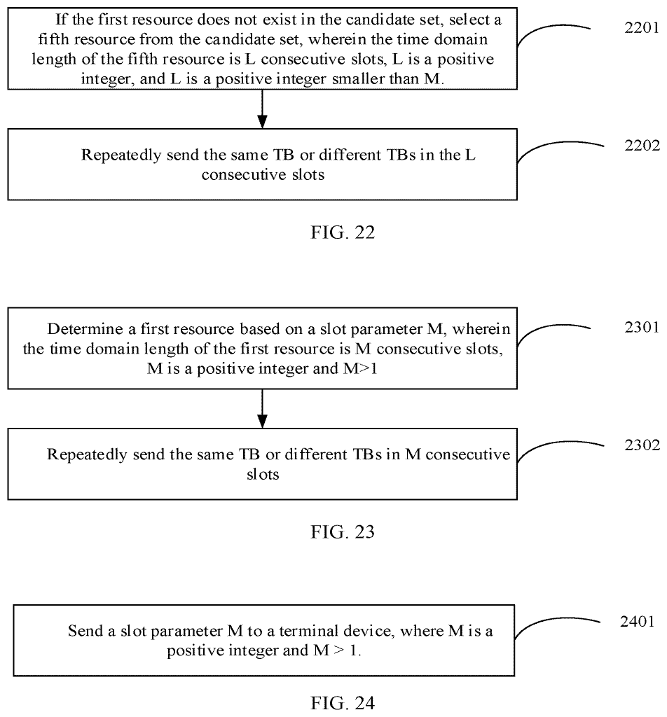

FIG. 22 is a schematic flowchart of a method for resource determination provided in an embodiment of the present disclosure. The method is performed by a terminal device. As shown in FIG. 22, the method may include the following steps:

In step 2201, if the first resource does not exist in the candidate set, a fifth resource is selected from the candidate set, wherein the time domain length of the fifth resource is L consecutive slots, L is a positive integer, and L is a positive integer smaller than M.

In step 2202, the same TB or different TBs are repeatedly sent in the L consecutive slots.

Furthermore, in an embodiment of the present disclosure, the fifth resource does not specifically refer to a fixed resource. For example, when the value of L in the L slots changes, the fifth resource may also change accordingly.

In summary, in the embodiment of the present disclosure, if the first resource does not exist in the candidate set, the fifth resource is selected in the candidate set, wherein the time domain length of the fifth resource is L consecutive slots, L is a positive integer, and L is a positive integer smaller than M, and the same TB or different TBs are repeatedly sent in L consecutive slots. In the embodiment of the present disclosure, if the first resource does not exist in the candidate resource set, it is determined that the terminal device cannot use M consecutive slots to send the same TB, and the terminal device can repeatedly send the same TB or different TBs in L consecutive slots. The embodiment can reduce the situation where the same TB or different TBs cannot be transmitted. The present disclosure provides a processing method for a “resource determination” scenario, and the method can repeatedly send the same TB or different TBs in L consecutive slots.

FIG. 23 is a schematic flowchart of a method for resource determination provided by an embodiment of the present disclosure. The method is performed by a terminal device. As shown in FIG. 23, the method may include the following steps:

In step 2301, a first resource is determined based on a slot parameter M, wherein the time domain length of the first resource is M consecutive slots, M is a positive integer and M>1.

In step 2302, the same TB or different TBs is (are) repeatedly sent in M consecutive slots.

In summary, in the embodiment of the present disclosure, based on the slot parameter M, the first resource is determined, wherein the time domain length of the first resource is M consecutive slots, M is a positive integer and M>1, and the same TB or different TBs are repeatedly sent in the M consecutive slots. In the embodiment of the present disclosure, the same TB or different TBs can be repeatedly sent in the M consecutive slots to reduce the situation where the same TB or different TBs cannot be transmitted. The present disclosure provides a processing method for a “resource determination” scenario, and the method can repeatedly send the same TB or different TBs in M consecutive slots.

FIG. 24 is a schematic flowchart of a method for resource determination provided by an embodiment of the present disclosure. The method is performed by a network side device. As shown in FIG. 24, the method may include the following steps:

In step 2401, a slot parameter M is sent to a terminal device, where M is a positive integer and M>1.

In summary, in the embodiment of the present disclosure, a slot parameter M is sent to the terminal device, where M is a positive integer and M>1. In the embodiment of the present disclosure, by sending the slot parameter M to the terminal device, the terminal device can select resources of M slots that are continuous in the time domain, thereby addressing the situation where continuous multi-slot resources cannot be selected based on the R16 or R17 sidelink resource selection mechanism. The present disclosure provides a processing method for a “resource determination” scenario, which can support the selection of consecutive multi-slot resources during resource selection to determine resources with a time domain length of M consecutive slots. Thus, the embodiment can facilitate the convenience of resource determination.

In an embodiment of the present disclosure, the method further includes: sending at least one of the following parameters to the terminal device:
a resource pool from which a resource is to be reported;
Layer 1 (L1) priority;
remaining packet delay budget;
the number of sub-channels or IRB indexes used for PSSCH or PSCCH transmission in a slot; or
a resource reservation interval.

For example, in an embodiment of the present disclosure, the network side device may send, to a terminal device, a slot parameter M, a resource pool from which a resource is to be reported, an L1 priority, a remaining packet delay budget, the number of sub-channels or IRB indexes for PSSCH or PSCCH transmission in a slot, and a resource reservation interval. The terminal device may receive the slot parameter M, the resource pool from which the resource is to be reported, the L1 priority, the remaining packet delay budget, the number of sub-channels or IRB indexes for PSSCH or PSCCH transmission in a slot, and the resource reservation interval, and the terminal device can determine a candidate resource set to determine the first resource.

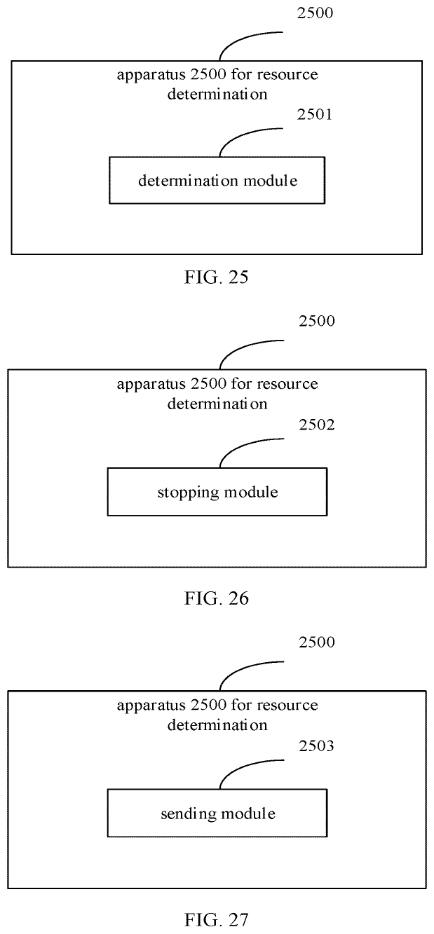

FIG. 25 is a schematic structural diagram of an apparatus 2500 for resource determination provided by an embodiment of the present disclosure. As shown in FIG. 25, the apparatus 2500 may include:
a determination module 2501 configured to determine a first resource based on a slot parameter M, wherein a time domain length of the first resource is M consecutive slots, M is a positive integer and M>1, and the first resource is used for sending a PSSCH or PSCCH.

In summary, in the apparatus for resource determination of the embodiment of the present disclosure, the first resource is determined based on the time slot parameter M by the determination module, where the time domain length of the first resource is M consecutive time slots, Mis a positive integer and M>1, and the first resource is used for sending the PSSCH or PSCCH. In the embodiment of the present disclosure, through the time slot parameter M, a resource with a time domain length of M consecutive time slots can be selected, which address the situation where continuous multi-slot resources cannot be selected based on the R16 or R17 sidelink resource selection mechanism. The present disclosure provides an apparatus for a “resource determination” scenario, which can support the selection of continuous multi-slot resources during resource selection to determine resources with a time domain length of M consecutive time slots. Thus, the embodiment of the present disclosure can facilitate the convenience of resource determination and improve the reliability of data transmission.

Optionally, in an embodiment of the present disclosure, the determination module 2501 determining the first resource based on the slot parameter M is specifically configured to:
receive the slot parameter M sent by a network side device, wherein the slot parameter M is used to indicate the number of consecutive sending slots for the PSSCH or the PSCCH; and
based on the slot parameter M, perform random resource selection in a candidate resource set to determine the first resource, wherein a slot length of each candidate resource in the candidate resource set is M slots.

Optionally, in an embodiment of the present disclosure, the first resource further includes L_{subCH} sub-channels which are continuous or discrete in a frequency domain, and frequency domain resource starting positions and ending positions are the same or different between adjacent slots, wherein L_{subCH} is a positive integer.

Optionally, in an embodiment of the present disclosure, the first resource further includes X indexes of Interlaced Resource Blocks (IRBs) which are continuous or discrete in a frequency domain, and frequency domain resource starting positions and ending positions are the same or different between adjacent slots, wherein X is a positive integer.

Optionally, in an embodiment of the present disclosure, the determination module 2301 determining the first resource based on the slot parameter M is specifically configured to:
based on the slot parameter M, determine the first resource from a candidate resource set, wherein a time domain length of each candidate resource in the candidate resource set is a single slot.

Optionally, in an embodiment of the present disclosure, the determination module 2501 determining the first resource from the candidate resource set based on the slot parameter M, including at least one of:
based on the slot parameter M, performing multiple resource selections from the candidate resource set to determine the first resource, wherein a slot length for each resource selection is a single slot; or
based on the slot parameter M, performing one resource selection from the candidate resource set to determine the first resource, wherein a slot length for the one resource selection is M slots.

Optionally, in an embodiment of the present disclosure, the determination module 2501 performing multiple resource selections from the candidate resource set based on the slot parameter M to determine the first resource is specifically configured to:
randomly select a first candidate resource x from the candidate resource set; and
based on the first candidate resource x, selecting, from the candidate resource set, candidate resources corresponding to M consecutive time domains as the first resource.

Optionally, in an embodiment of the present disclosure, the determination module 2501 is further configured to:
if a first resource cannot be selected from the candidate resource set based on the first candidate resource x, reselect a second candidate resource x from the candidate resource set, and performing selection of the first resource from the candidate resource set again based on the second candidate resource x.

Optionally, in an embodiment of the present disclosure, the determination module 2501 selecting, from the candidate resource set, candidate resources corresponding to M consecutive time domains as the first resource is configured to:
select, from the candidate resource set, candidate resources corresponding to M consecutive time domains according to a first selection order as the first resource.

Optionally, in an embodiment of the present disclosure, the determination module 2501 is further configured to:
if candidate resources corresponding to M consecutive time domains cannot be selected from the candidate resource set according to the first selection order, obtain candidate resources corresponding to N consecutive time domains selected according to the first selection order as a second resource, where N is a positive integer smaller than M;
based on the first candidate resource x again, select, from the candidate resource set, candidate resources corresponding to M-N consecutive time domains according to a second selection order as a third resource; and combining the second resource and the third resource as the first resource.

Optionally, in an embodiment of the present disclosure, the second selection order is in a direction opposite to the first selection order.

Optionally, in an embodiment of the present disclosure, the determination module 2501 performing one resource selection from the candidate resource set based on the slot parameter M to determine the first resource is specifically configured to:
determine a plurality of candidate resource subsets, wherein time domain resources in the candidate resource subset are continuous, and a length of time domain continuity is equal to or greater than the M slots; and
performing selection from any one of the candidate resource subsets to select candidate resources corresponding to M consecutive time domains as the first resource.

Optionally, in an embodiment of the present disclosure, FIG. 26 is a schematic structural diagram of an apparatus for resource determination provided by an embodiment of the present disclosure. As shown in FIG. 26, the apparatus 2500 may further include: a stopping module 2502 configured to, if the first resource does not exist in the candidate resource set, stop transmission of a TB.

Optionally, in an embodiment of the present disclosure, FIG. 27 is a schematic structural diagram of an apparatus for resource determination provided by an embodiment of the present disclosure. As shown in FIG. 27, the apparatus 2500 may further include: a sending module 2503 configured to, if the first resource does not exist in the candidate resource set, randomly select a fourth resource from the candidate resource set, wherein a time domain length of the fourth resource is a single slot; and
send a TB in the single slot.

Optionally, in an embodiment of the present disclosure, the determination module 2501 is further configured to:
if the first resource does not exist in the candidate resource set, selecting a fifth resource from the candidate set, wherein a time domain length of the fifth resource is L consecutive slots, L is a positive integer and L is a positive integer smaller than M.

Optionally, in an embodiment of the present disclosure, the sending module 2503 is further configured to:
repeatedly send a same TB or different TBs in the M consecutive slots or in the L consecutive slots.

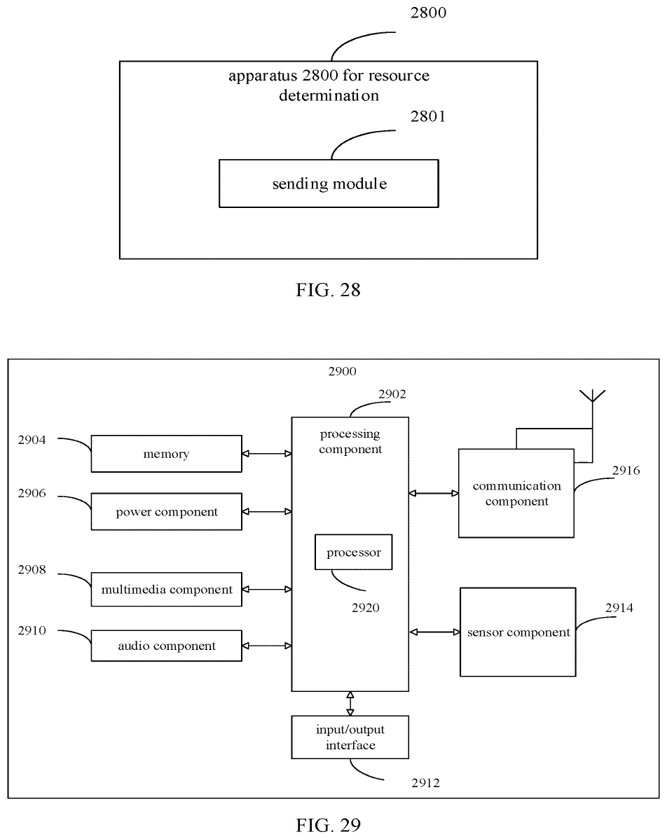

FIG. 28 is a schematic structural diagram of an apparatus for resource determination provided by an embodiment of the present disclosure. As shown in FIG. 28, the apparatus 2800 may include:
a sending module 2801 configured to send a slot parameter M to a terminal device, wherein M is a positive integer and M>1.

In summary, in the apparatus for resource determination of the embodiment of the present disclosure, a time slot parameter M is sent to the terminal device through a sending module, wherein M is a positive integer and M>1. In the embodiment of the present disclosure, by sending the time slot parameter M to the terminal device, the terminal device can select resources of M time slots that are continuous in the time domain, thereby addressing the situation that continuous multi-slot resources cannot be selected based on the R16 or R17 sidelink resource selection mechanism. The present disclosure provides a processing apparatus for a “resource determination” scenario, which can support the selection of continuous multi-slot resources during resource selection to determine resources with a time domain length of M continuous time slots. Thus, the embodiment can facilitate the convenience of resource determination.

Optionally, in an embodiment of the present disclosure, the sending module 2801 is further configured to send, to the terminal device, at least one of the following parameters:
a resource pool from which a resource is to be reported;
layer 1 (L1) priority;
remaining packet delay budget;
the number of sub-channels or IRB indexes to be used for PSSCH or PSCCH transmission in a slot; or
a resource reservation interval,
wherein the terminal device is configured to determine a candidate resource set according to the at least one of the parameters.

FIG. 29 is a block diagram of a terminal device UE 2900 provided by an embodiment of the present disclosure. For example, the UE 2900 may be a mobile phone, a computer, a digital broadcast terminal device, a messaging device, a gaming console, a tablet, a medical device, exercise equipment, a personal digital assistant, and the like.

Referring to FIG. 29, the UE 2900 may include at least one of the following components: a processing component 2902, a memory 2904, a power component 2906, a multimedia component 2908, an audio component 2910, an input/output (I/O) interface 2912, a sensor component 2914, and a communication component 2916.

The processing component 2902 typically controls overall operations of the UE 2900, such as the operations associated with display, telephone calls, data communications, camera operations, and recording operations. The processing component 802 may include at least one processor 2920 to execute instructions to perform all or part of the steps in the above described methods. Moreover, the processing component 2902 may include at least one module which facilitates the interaction between the processing component 2902 and other components. For instance, the processing component 2902 may include a multimedia module to facilitate the interaction between the multimedia component 808 and the processing component 2902.

The memory 2904 is configured to store various types of data to support the operation of the UE 2900. Examples of such data include instructions for any applications or methods operated on the UE 2900, contact data, phonebook data, messages, pictures, video, etc. The memory 2904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2906 provides power to various components of the UE 2900. The power component 2906 may include a power management system, at least one power source, and any other components associated with the generation, management, and distribution of power in the UE 2900.

The multimedia component 2908 includes a screen providing an output interface between the UE 2900 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensors may not only sense a boundary of a touch or swipe action, but also sense a wake-up period of time and a pressure associated with the touch or swipe action. In some embodiments, the multimedia component 2908 includes a front camera and/or a rear camera. The front camera and the rear camera may receive an external multimedia datum while the UE 2900 is in an operation mode, such as a photographing mode or a video mode. Each of the front camera and the rear camera may be a fixed optical lens system or have focus and optical zoom capability.

The audio component 2910 is configured to output and/or input audio signals. For example, the audio component 2910 includes a microphone (“MIC”) configured to receive an external audio signal when the UE 2900 is in an operation mode, such as a call mode, a recording mode, and a voice recognition mode. The received audio signal may be further stored in the memory 804 or transmitted via the communication component 2916. In some embodiments, the audio component 2910 further includes a speaker to output audio signals.

The I/O interface 2912 provides an interface between the processing component 2902 and peripheral interface modules, such as a keyboard, a click wheel, buttons, and the like. The buttons may include, but are not limited to, a home button, a volume button, a starting button, and a locking button.

The sensor component 2914 includes at least one sensor to provide status assessments of various aspects of the UE 2900. For instance, the sensor component 2914 may detect an open/closed status of the UE 2900, relative positioning of components, e.g., the display and the keypad, of the UE 2900, a change in position of the UE 2900 or a component of the UE 2900, a presence or absence of user contact with the UE 2900, an orientation or an acceleration/deceleration of the UE 2900, and a change in temperature of the UE 2900. The sensor component 2914 may include a proximity sensor configured to detect the presence of nearby objects without any physical contact. The sensor component 2914 may also include a light sensor, such as a CMOS or CCD image sensor, for use in imaging applications. In some embodiments, the sensor component 2914 may also include an accelerometer sensor, a gyroscope sensor, a magnetic sensor, a pressure sensor, or a temperature sensor.

The communication component 2916 is configured to facilitate communication, wired or wirelessly, between the UE 2900 and other devices. The UE 2900 can access a wireless network based on a communication standard, such as WiFi, 2G, or 3G, or a combination thereof. In one example embodiment, the communication component 2916 receives a broadcast signal or broadcast associated information from an external broadcast management system via a broadcast channel. In one example embodiment, the communication component 2916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the UE 2900 may be implemented with at least one application specific integrated circuit (ASIC), digital signal processor (DSP), digital signal processing device (DSPD), programmable logic device (PLD), field programmable gate arrays (FPGA), controller, micro-controller, microprocessor, or other electronic component, for performing the above described methods.

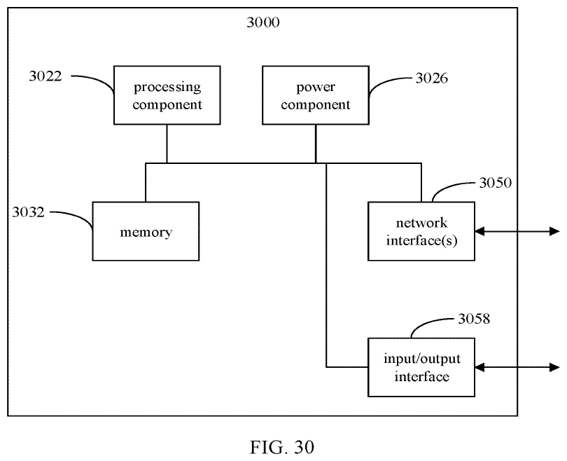

FIG. 30 is a block diagram of a network side device 3000 provided by an embodiment of the present disclosure. For example, the network side device 3000 may be provided as a network side device. The network element may be the first network element, the second network element or the third network element described above. Referring to FIG. 30, the network side device 3000 includes a processing component 3022 that further includes at least one processor, and memory resources represented by a memory 3032 for storing instructions executable by the processing component 3022, such as application programs. The application programs stored in the memory 3032 may include one or more modules each corresponding to a set of instructions. Further, the processing component 3022 is configured to execute the instructions to perform any of the above described methods which are applied at the network side device, for example, the method shown in FIG. 24.

The network side device 3000 may also include a power component 3026 configured to perform power management of the network side device 3000, wired or wireless network interface(s) 3050 configured to connect the network side device 3000 to a network, and an input/output (I/O) interface 3058. The network side device 3000 may operate based on an operating system stored in the memory 3032, such as Windows Server™, Mac OS X™, Unix™, Linux™, FreeBSD™, or the like.

In the above embodiments provided by the present disclosure, the methods provided by the embodiments of the present disclosure are described from the perspectives of the network side device and the UE. In order to implement the functions in the methods provided by the above embodiments of the present disclosure, the network side device and the UE may include a hardware structure or a software module, and implement the above functions in the form of the hardware structure, the software module, or the hardware structure plus the software module. One of the above functions may be executed in the form of the hardware structure, the software module, or the hardware structure plus the software module.

An embodiment of the present disclosure provides a communication apparatus. The communication apparatus may include a transceiving module and a processing module. The transceiving module may include a sending module and/or a receiving module, the sending module is used to implement a sending function, the receiving module is used to implement a receiving function, and the transceiving module may implement a sending function and/or a receiving function.

The communication apparatus may be a terminal device (such as the terminal device in the aforementioned method embodiments), or an apparatus in the terminal device, or an apparatus that can be used in conjunction with the terminal device. Alternatively, the communication apparatus may be a network device, or an apparatus in the network device, or an apparatus that can be used in conjunction with the network device.

An embodiment of the present disclosure provides another communication apparatus. The communication apparatus may be a network device, or a terminal device (for example, the terminal device in the aforementioned method embodiments), or a chip, a chip system or a processor that supports a network device to implement the above methods, or a chip, a chip system or a processor that supports a terminal device to implement the above methods, etc. The apparatus may be configured to implement the methods described in the above method embodiments. For details, reference may be made to the descriptions in the above method embodiments.

The communication apparatus may include one or more processors. The processor(s) may be a general-purpose processor or a special-purpose processor, etc. For example, it can be a baseband processor or a central processor. The baseband processor may be used to process communication protocols and communication data, and the central processor may be used to control the communication apparatus (such as network side device, baseband chip, terminal device, terminal device chip, DU or CU, etc.), executes a computer program, and processes data for a computer program.

Optionally, the communication apparatus may further include one or more memories, on which a computer program may be stored, and the processor executes the computer program, so that the communication apparatus performs the methods described in the above method embodiments. Optionally, data may also be stored in the memory. The communication apparatus and the memory may be provided separately or integrated together.

Optionally, the communication apparatus may further include a transceiver and an antenna. The transceiver may be called a transceiving unit, a transceiving device, or a transceiving circuit, etc., and is configured to realize sending and receiving functions. The transceiver may include a receiver and a sender. The receiver may be called a receiving device or a receiving circuit, etc., and is configured to realize the receiving function; the sender may be called a sending device or a sending circuit, etc., and is configured to realize the sending function.

Optionally, the communication apparatus may further include one or more interface circuits. The interface circuits are configured to receive code instructions and transmit them to the processor. The processor executes the code instructions to cause the communication apparatus to perform the methods described in the above method embodiments.

The communication apparatus is a terminal device (for example, the terminal device in the aforementioned method embodiments): the processor is configured to perform any one of the methods shown in FIG. 2 to FIG. 23.

The communication apparatus is a network side device: the processor is configured to perform the method shown in FIG. 24.

In one implementation, a transceiver for implementing receiving and sending functions may be included in the processor. For example, the transceiver may be a transceiving circuit, or an interface, or an interface circuit. The transceiving circuit, interface or interface circuit configured to implement the receiving and sending functions may be separate or integrated together. The above-mentioned transceiving circuit, interface or interface circuit may be used for reading and writing of codes/data, or the above-mentioned transceiving circuit, interface or interface circuit may be used for signal transmission or delivery.

In one implementation, the processor may store a computer program, and the computer program is run on the processor, causing the communication apparatus to perform the methods described in the above method embodiments. The computer program may be solidified in the processor, in which case the processor may be implemented in hardware.

In one implementation, the communication apparatus may include a circuit, and the circuit may implement the functions of sending or receiving or communicating in the foregoing method embodiments. The processor and transceiver described in the present disclosure may be implemented in Integrated Circuit (IC), analog IC, Radio Frequency Integrated Circuit (RFIC), mixed signal IC, Application Specific Integrated Circuit (ASIC), Printed Circuit Board (PCB), electronic device, and so on. The processor and transceiver may also be manufactured using various IC process technologies, such as Complementary Metal Oxide Semiconductor (CMOS), nMetal-Oxide-Semiconductor (NMOS), Positive Channel Metal Oxide Semiconductor (PMOS), Bipolar Junction Transistor (BJT), bipolar CMOS (BiCMOS), silicon germanium (SiGe), gallium arsenide (GaAs), etc.

The communication apparatus described in the above embodiments may be a network device, or a terminal device (for example, the terminal device in the aforementioned method embodiments), but the scope of the communication apparatus described in the present disclosure is not limited thereto, and the structure of the communication apparatus is not limited by the drawings. The communication apparatus may be a stand-alone device or may be part of a larger device. For example, the communication apparatus may be:
(1) an independent integrated circuit (IC), or a chip, or a chip system or subsystem;
(2) a collection of one or more ICs; optionally, the IC collection may further include a storage component for storing data and computer programs;
(3) ASIC, such as modem;
(4) a module that can be embedded in other device(s);
(5) a receiver, a terminal device, an intelligent terminal device, a cellular phone, a wireless device, a handheld device, a mobile unit, a vehicle-mounted device, a network device, a cloud device, an artificial intelligence device, etc.;
(6) others, etc.

For a case where the communication apparatus can be a chip or a chip system, the chip includes a processor and an interface. The number of processors may be one or more, and the number of interfaces may be more than one.

Optionally, the chip further includes a memory, and the memory is configured to store necessary computer programs and data.

Those skilled in the art can also understand that the various illustrative logical blocks and steps listed in the embodiments of the present disclosure may be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as beyond the scope of protection of the embodiments of the present disclosure.

The present disclosure also provides a readable storage medium on which instructions are stored, and when the instructions are executed by a computer, the functions of any of the above method embodiments are implemented.

The present disclosure also provides a computer program product, which, when executed by a computer, implements the functions of any of the above method embodiments.

The present disclosure further provides the following example embodiments.

Optionally, in an embodiment of the present disclosure, determining the first resource based on the slot parameter M includes:
receiving the slot parameter M sent by a network side device, wherein the slot parameter M is used to indicate the number of consecutive sending slots for the PSSCH or the PSCCH; and
based on the slot parameter M, performing random resource selection in a candidate resource set to determine the first resource, wherein a slot length of each candidate resource in the candidate resource set is M slots.

Optionally, in an embodiment of the present disclosure, the first resource further includes L_{subCH} sub-channels which are continuous or discrete in a frequency domain, and frequency domain resource starting positions and ending positions are the same or different between adjacent slots, wherein L_{subCH} is a positive integer.

Optionally, in an embodiment of the present disclosure, the first resource further includes X indexes of Interlaced Resource Blocks (IRBs) which are continuous or discrete in a frequency domain, and frequency domain resource starting positions and ending positions are the same or different between adjacent slots, wherein X is a positive integer.

Optionally, in an embodiment of the present disclosure, determining the first resource based on the slot parameter M includes:
based on the slot parameter M, determining the first resource from a candidate resource set, wherein a time domain length of each candidate resource in the candidate resource set is a single slot.

Optionally, in an embodiment of the present disclosure, determining the first resource from the candidate resource set based on the slot parameter M includes at least one of:
based on the slot parameter M, performing multiple resource selections from the candidate resource set to determine the first resource, wherein a slot length for each resource selection is a single slot;
based on the slot parameter M, performing one resource selection from the candidate resource set to determine the first resource, wherein a slot length for the one resource selection is M slots.

Optionally, in an embodiment of the present disclosure, performing multiple resource selections from the candidate resource set based on the slot parameter M to determine the first resource includes:
randomly selecting a first candidate resource x from the candidate resource set; and
based on the first candidate resource x, selecting, from the candidate resource set, candidate resources corresponding to M consecutive time domains as the first resource.

Optionally, in an embodiment of the present disclosure, the method further includes:
if no first resource is selected from the candidate resource set based on the first candidate resource x, reselecting a second candidate resource x from the candidate resource set, and selecting the first resource again from the candidate resource set based on the second candidate resource x.

Optionally, in an embodiment of the present disclosure, selecting, from the candidate resource set, candidate resources corresponding to M consecutive time domains as the first resource includes:
selecting, from the candidate resource set, candidate resources corresponding to M consecutive time domains according to a first selection order as the first resource.

Optionally, in an embodiment of the present disclosure, the method further includes:
if no candidate resources corresponding to M consecutive time domains are selected from the candidate resource set according to the first selection order, obtaining candidate resources corresponding to N consecutive time domains selected according to the first selection order as a second resource, where N is a positive integer smaller than M;
based on the first candidate resource x, selecting, from the candidate resource set, candidate resources corresponding to M-N consecutive time domains again according to a second selection order as a third resource; and
combining the second resource and the third resource as the first resource.

Optionally, in an embodiment of the present disclosure, the second selection order is in a direction opposite to the first selection order.

Optionally, in an embodiment of the present disclosure, performing one resource selection from the candidate resource set based on the slot parameter M to determine the first resource includes:
determining a plurality of candidate resource subsets, wherein time domain resources in the candidate resource subset are continuous, and a length of time domain continuity is equal to or greater than the M slots; and
performing selection from any one of the candidate resource subsets to select candidate resources corresponding to M consecutive time domains as the first resource.

Optionally, in an embodiment of the present disclosure, the method further includes:
if the first resource does not exist in the candidate resource set, stopping transmission of a TB.

Optionally, in an embodiment of the present disclosure, the method further includes:
if the first resource does not exist in the candidate resource set, randomly selecting a fourth resource from the candidate resource set, wherein a time domain length of the fourth resource is a single slot; and
sending a TB in the single slot.

Optionally, in an embodiment of the present disclosure, the method further includes:
if the first resource does not exist in the candidate resource set, selecting a fifth resource from the candidate set, wherein a time domain length of the fifth resource is L consecutive slots, L is a positive integer and L is a positive integer smaller than M.

Optionally, in an embodiment of the present disclosure, the method further includes:
repeatedly sending a same TB or different TBs in the M consecutive slots or in the L consecutive slots.

Optionally, in an embodiment of the present disclosure, the method further includes:
sending, to the terminal device, at least one of the following parameters, wherein the terminal device is configured to determine a candidate resource set according to the at least one of the parameters:
a resource pool from which a resource is to be reported;
layer 1 (L1) priority;
remaining packet delay budget;
the number of sub-channels or IRB indexes to be used for PSSCH or PSCCH transmission in a slot;
a resource reservation interval.

In summary, in the embodiments of the present disclosure, a first resource is determined based on a slot parameter M. A time domain length of the first resource is M consecutive slots, M is a positive integer and M>1, and the first resource is used for sending of a PSSCH or PSCCH. In the embodiments of the present disclosure, through the slot parameter M, a resource with a time domain length of M consecutive time slots can be selected to address the situation where consecutive multi-slot resources cannot be selected based on the R16 or R17 sidelink resource selection mechanism. The present disclosure provides a processing method for a “resource determination” scenario, which can support the selection of consecutive multi-slot resources during resource selection to determine resource(s) with a time domain length of M consecutive time slots. Thus, the present disclosure can facilitate the convenience of resource determination and improve the reliability of data transmission.

The above embodiments may be implemented in whole or in part by software, hardware, firmware, or any combination thereof. When implemented in software, the embodiments may be implemented in whole or in part in the form of a computer program product. The computer program product includes one or more computer programs. When the computer program is loaded and executed on a computer, processes or functions described in accordance with the embodiments of the present disclosure are generated in whole or in part. The computer may be a general-purpose computer, a special-purpose computer, a computer network, or other programmable device. The computer program may be stored in a computer-readable storage medium, or may be transferred from one computer-readable storage medium to another, for example, the computer program may be transferred from a website, computer, server, or data center to another website, computer, server or data center through wired (such as coaxial cable, optical fiber, Digital Subscriber Line (DSL)) or wireless (such as infrared, wireless, microwave, etc.) means. The computer-readable storage medium may be any available medium that can be accessed by a computer or a data storage device such as a server, data center, etc. that contains one or more available media integrated. The available medium may be magnetic medium (for example, floppy disk, hard disk, magnetic tape), optical medium (for example, high-density Digital Video Disc (DVD)), or semiconductor medium (for example, Solid State Disk (SSD)), etc.

Those of ordinary skill in the art can understand that first, second, and other numerical numbers involved in the present disclosure are only for convenience of description and are not used to limit the scope of the embodiments of the disclosure, nor to indicate a sequential order.

The term “at least one” in the present disclosure can also be described as one or a plurality of, and the plurality can be two, three, four or more, and the present disclosure is not limited thereto. In the embodiments of the present disclosure, for a kind of technical features, “first”, “second”, “third”, “A”, “B”, “C” and “D”, etc. are used to distinguish technical features in the kind of technical features, and technical features described associated with “first”, “second”, “third”, “A”, “B”, “C” and “D” are in no particular sequential order or order of size.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A method for resource determination, wherein the method is performed by a terminal device, and the method comprises:
determining a first resource based on a slot parameter M, wherein a time domain length of the first resource is M consecutive slots, M is a positive integer and M>1, and the first resource is used for a Physical Sidelink Shared Channel (PSSCH) or a Physical Sidelink Control Channel (PSCCH) transmission.

2. The method according to claim 1, wherein determining the first resource based on the slot parameter M comprises:
receiving the slot parameter M sent by a network side device, wherein the slot parameter M is used to indicate the number of consecutive slots for the PSSCH or the PSCCH transmission; and
based on the slot parameter M, performing random resource selection in a candidate resource set to determine the first resource, wherein a slot length of each candidate resource in the candidate resource set is M slots.

3. The method according to claim 2, wherein the first resource further comprises L_{subCH} sub-channels which are continuous or discrete in a frequency domain, and frequency domain resource starting positions and ending positions are the same or different between adjacent slots, wherein L_{subCH} is a positive integer.

4. The method according to claim 2, wherein the first resource further comprises X indexes of Interlaced Resource Blocks (IRBs) which are continuous or discrete in a frequency domain, and frequency domain resource starting positions and ending positions are the same or different between adjacent slots, wherein X is a positive integer.

5. The method according to claim 1, wherein determining the first resource based on the slot parameter M comprises:
based on the slot parameter M, determining the first resource from a candidate resource set, wherein a time domain length of each candidate resource in the candidate resource set is a single slot.

6. The method according to claim 5, wherein determining the first resource from the candidate resource set based on the slot parameter M comprises at least one of:
based on the slot parameter M, performing multiple resource selections from the candidate resource set to determine the first resource, wherein a slot length for each resource selection is a single slot; or
based on the slot parameter M, performing one resource selection from the candidate resource set to determine the first resource, wherein a slot length for the one resource selection is M slots.

7. The method according to claim 6, wherein performing multiple resource selections from the candidate resource set based on the slot parameter M to determine the first resource comprises:
randomly selecting a first candidate resource x from the candidate resource set; and
based on the first candidate resource x, selecting, from the candidate resource set, candidate resources corresponding to M consecutive time domains as the first resource.

8. The method according to claim 7, further comprising:
in response to no first resource being selected from the candidate resource set based on the first candidate resource x, reselecting a second candidate resource x from the candidate resource set, and performing selection of the first resource from the candidate resource set again based on the second candidate resource x.

9. The method according to claim 7, wherein selecting, from the candidate resource set, candidate resources corresponding to M consecutive time domains as the first resource comprises:
selecting, from the candidate resource set, candidate resources corresponding to M consecutive time domains according to a first selection order as the first resource.

10. The method according to claim 9, further comprising:
in response to no candidate resources corresponding to M consecutive time domains being selected from the candidate resource set according to the first selection order, obtaining candidate resources corresponding to N consecutive time domains selected according to the first selection order as a second resource, where N is a positive integer smaller than M;
based on the first candidate resource x again, selecting, from the candidate resource set, candidate resources corresponding to M-N consecutive time domains according to a second selection order as a third resource; and
combining the second resource and the third resource as the first resource.

11. The method according to claim 10, wherein the second selection order is in a direction opposite to the first selection order.

12. The method according to claim 6, wherein performing one resource selection from the candidate resource set based on the slot parameter M to determine the first resource comprises:
determining a plurality of candidate resource subsets, wherein time domain resources in each of the plurality of candidate resource subsets are continuous, and a length of time domain continuity is equal to or greater than the M slots; and
performing selection from any one of the candidate resource subsets to select candidate resources corresponding to M consecutive time domains as the first resource.

13. The method according to claim 1, further comprising:
in response to the first resource not existing in the candidate resource set, stopping transmission of a Transmission Block (TB); or
in response to the first resource not existing in the candidate resource set, randomly selecting a fourth resource from the candidate resource set, wherein a time domain length of the fourth resource is a single slot, and transmitting a TB in the single slot.

14. (canceled)

15. The method according to claim 1, further comprising:
if the first resource does not exist in the candidate resource set, selecting a fifth resource from the candidate resource set, wherein a time domain length of the fifth resource is L consecutive slots, and L is a positive integer smaller than M.

16. The method according to claim 15, further comprising:
repeatedly transmitting a same TB or different TBs in the M consecutive slots or in the L consecutive slots.

17. A method for resource determination, wherein the method is performed by a network side device, and the method comprises:
sending a slot parameter M to a terminal device, wherein M is a positive integer and M>1.

18. The method according to claim 17, further comprising:
sending, to the terminal device, at least one of the following parameters:
a resource pool from which a resource is to be reported;
layer 1 (L1) priority;
remaining packet delay budget;
the number of sub-channels or IRB indexes to be used for PSSCH or PSCCH transmission in a slot; or
a resource reservation interval,
wherein the terminal device is configured to determine a candidate resource set according to the at least one of the parameters.

19-20. (canceled)

21. A terminal device, comprising a processor and a memory, wherein the memory stores a computer program, and the processor executes the computer program stored in the memory to cause the device to:
determine a first resource based on a slot parameter M, wherein a time domain length of the first resource is M consecutive slots, M is a positive integer and M>1, and the first resource is used for a Physical Sidelink Shared Channel (PSSCH) or a Physical Sidelink Control Channel (PSCCH) transmission.

22. A network side device, comprising a processor and a memory, wherein the memory stores a computer program, and the processor executes the computer program stored in the memory to cause the device to perform the method according to claim 17.

23-24. (canceled)

25. A non-transitory computer-readable storage medium storing instructions, wherein when the instructions are executed, the method according to claim 1 is implemented.

26. (canceled)
